(19) United States
(12) Patent Application Publication
(10) Pub. No.: US 2015/0113105 A1
(43) Pub. Date: Apr. 23, 2015

(54) AUTOMATED PROVISIONING OF A HYBRID NETWORK

(71) Applicant: APH, Inc., dba Codero Hosting, Overland Park, KS (US)

(72) Inventors: Jason ACKLEY, Austin, TX (US); Stan ANTOV, Overland Park, KS (US); Tom MARTIN, Overland Park, KS (US); Chandler VAUGHN, Austin, TX (US)

(21) Appl. No.: 14/521,439

(22) Filed: Oct. 22, 2014

Related U.S. Application Data
(60) Provisional application No. 61/894,409, filed on Oct. 22, 2013.

(51) Int. Cl. H04L 12/24

(52) U.S. Cl. CPC H04L 41/0803
USPC 709/220

(57) ABSTRACT

An improved provisioning process for a hybrid network that makes use of Layer 2 technologies instead of Layer 3 technologies to enable automated provisioning of a custom hybrid network for a customer. In some embodiments, the automated provisioning can commence after a customer makes selections of the servers and/or services to be included in the hybrid network. The customer selections can trigger an automated process whereby the resources to be shared can be added, and the networking configuration and protocols can be automatically configured for all communication between all of the servers/components on the hybrid network

### CROSS-REFERENCE TO RELATED APPLICATION

The present claims priority under 35 U.S.C. §119(e) to U.S. Provisional App. No. 61/894,409, entitled “HYBRID NETWORK AUTOMATION”, by Jason ACKLEY et al., filed Oct. 22, 2013, which is assigned to the current assignee hereof and incorporated herein by reference in its entirety.

### FIELD OF THE DISCLOSURE

The present invention relates in general to cloud computing, and more particularly to provisioning a cloud network.

### BACKGROUND

Cloud computing platforms are becoming popular with clients and customers by providing flexible, on-demand resources at a relatively low cost. A cloud computing network enables clients to manage applications and/or data resources by dynamically leasing (sharing) computational resources and associated network resources from service providers. These applications and/or data resources may be used by customers of the clients, individuals associated with the clients, and/or by the clients themselves. This dynamic leasing of computational and network resources creates an appearance and function of a dedicated computer network.

Cloud computing systems typically come in one of three forms: public, private, and hybrid. These three types differ from each other in terms of both type and location of underlying hardware and privacy of data. For example, in a public cloud, the services and infrastructure are all provided off-site and access is via an internet connection. Public clouds offer the greatest level of efficiency in shared resources, but the data is more vulnerable because it is located on an off-site shared server. A private cloud is one where the services and infrastructure are maintained on a private network (with no public access). Usually the infrastructure is located on-premises, although the network can also be externally hosted. Private clouds are much more secure, but lack many of the advantages of public clouds such as increased efficiency of resource usage (and thus lower costs) and on-demand scalability.

Finally, hybrid clouds combine public and private cloud services to provide many of the advantages of both public and private clouds, while mitigating the disadvantages. A hybrid cloud allows a client to provision both dedicated private servers and storage and shared cloud servers and storage on the same network. This allows a client to keep mission-critical applications and information in-house on dedicated servers safe from third-party access, while applications and data with fewer security concerns is available on the shared public platform.

Unfortunately, hybrid clouds present their own set of challenges. Managing the information flow in a hybrid cloud environment can be difficult. On-premises servers must share information with applications hosted off-premises by public cloud providers (servers) and this information may change constantly. Hybrid cloud environments also typically include a complex mix of policies, permissions, and limits that must be managed consistently across both public and private clouds.

Provisioning is the process of preparing and equipping a cloud network to allow it to provide new and/or additional services to its clients. New resources provisioned for a client may be added as needed by the service provider allocating an additional portion of the shared computational and network resources to the client. Additionally, service providers can dynamically multiplex resources among multiple clients without dedicating individual physical resources to each client.

Typically, the provisioning process has been both time and labor intensive, with provisioning requiring from tens of minutes to several hours to in many cases days or even weeks to complete. Provisioning is particularly difficult for hybrid clouds because the computing, network, and storage resources must be managed across multiple domains. Because of the delay required to bring new computing resources online, some clients still prefer traditional dedicated data centers for time-sensitive computing, even with the higher overhead costs for the hardware, infrastructure, maintenance, and energy used by dedicated computer systems. In some cases this problem has been addressed by creating an artificial hybrid network by setting up a proprietary bridge between dedicated infrastructure and cloud infrastructure. But such an approach is problematic due to the fact that the bridge is frail and prone to failure and tends to cause a data/communication, bottle neck.

What is needed therefore is a natively hybrid network with improved provisioning.

### SUMMARY OF THE INVENTION

An object of the invention, therefore, is to provide such an improved provisioning process for a hybrid network. Preferred embodiments make use of Layer 2 technologies instead of Layer 3 technologies to enable automated provisioning of a custom hybrid network for a customer. In some embodiments, the automated provisioning can commence after a customer makes selections of the servers and/or services to be included in the hybrid network. The customer selections can trigger an automated process whereby the resources to be shared can be added, and the networking configuration and protocols can be automatically configured for all communication between all of the servers/components on the hybrid network.

In one aspect, a method of provisioning a hybrid network according to embodiments described herein can comprise providing a hybrid network where at least a plurality of servers and/or systems in the network are connected to each other by using a layer 2 switching device; receiving an order from a user requesting the creation of a hybrid network and the addition of at least two servers and/or systems to the network; and automatically provisioning the requested hybrid network without manual intervention.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The present disclosure may be better understood, and its numerous features and advantages made apparent to those skilled in the art by referencing the accompanying drawings.

FIG. 1 illustrates a high-level overview of a hybrid network suitable for automated provisioning according to embodiments of the present invention.

FIG. 2 shows an example of system logic that could be used to provision hybrid service on a hybrid network according to an embodiment.

FIG. 3 shows an example of system logic that could be used to assign a server (or servers) to the hybrid network according to an embodiment.

FIG. 4 shows an example of system logic that could be used to view the hybrid service servers according to an embodiment.

FIG. 5 shows an example of system logic that could be used to automatically remove a server (or servers) from the hybrid network according to an embodiment.

FIG. 6 shows an example of system logic that could be used to automatically de-provision an entire hybrid network according to an embodiment.

The accompanying drawings are not intended to be drawn to scale. In the drawings, each identical or nearly identical component that is illustrated in various figures is represented by a like numeral. For purposes of clarity, not every component may be labeled in every drawing.

### DETAILED DESCRIPTION OF PREFERRED EMBODIMENTS

Hybrid networks provide many of the benefits of public clouds such as reduced costs (due to sharing of computing resources) and on-demand scalability, while retaining the advantages of private clouds such as a dedicated architecture that fulfills the needs of security, control, and performance. Unfortunately, provisioning hybrid networks is challenging, especially where on-premises servers must share information with applications and servers hosted off-premises. Further, virtually all large cloud network within service providers and large companies today end up deployed so that there are mandated logical separations in terms of subnets and failure domains. This results in isolated “silos” of network communication that cannot be easily shared with the rest of the network.

Typically layer 3 technologies such as VPNs are used to implement and manage data sharing and communication between different servers in a hybrid network and between isolate silos resulting from the separation of subnets. Unfortunately, layer 3 technologies are themselves difficult to setup and manage.

The OSI, or Open System Interconnection, is a networking model comprised of seven “layers” representing a controlled hierarchy of information transmission extending from physical electrical impulses all the way to applications. OSI Layer 2 is a data link where data packets are encoded and decoded into bits. The MAC (Media Access Control) sub layer controls how a computer on the network gains access to the data and permission to transmit it and the LLC (Logical Link control) layer controls frame synchronization, flow control and error checking. OSI Layer 3 provides switching and routing technologies, creating logical paths, known as virtual circuits, for transmitting data from node to node. Routing and forwarding are functions of this layer, as well as addressing, internetworking, error handling, congestion control and packet sequencing.

Embodiments of the present invention make use of Layer 2 technologies instead of Layer 3 technologies to enable automated provisioning of a custom hybrid network for a customer. In some embodiments, the automated provisioning can commence after a customer makes selections of the servers and/or services to be included in the hybrid network. As discussed below, those selections can trigger an automated process whereby the resources to be shared can be added, and the networking configuration and protocols can be automatically configured to all communication between all of the servers/components on the hybrid network.

Layer 3 technologies have a number of advantages over layer 2 technologies in terms of limiting broadcast traffic such as ARP and DHCP broadcasts to the local network, and the inherent concept of subnetting allowing administrators to chop networks up into smaller parts to limit broadcasting, however, using layer 3 technology such as VPNs also requires a great deal of additional setup. A typical provisioning process using layer 3 technologies typically requires a manual entry of certain types of data such as setting routing tables on network interfaces and making sure shared security credentials are synchronized between the systems communicating over VPN. While layer 2 technologies are considered “old′ technology by today's standards, Applicants have realized that the use of layer 2 technology to transfer data within a hybrid network provides a very significant advantage in provisioning a new or existing network.

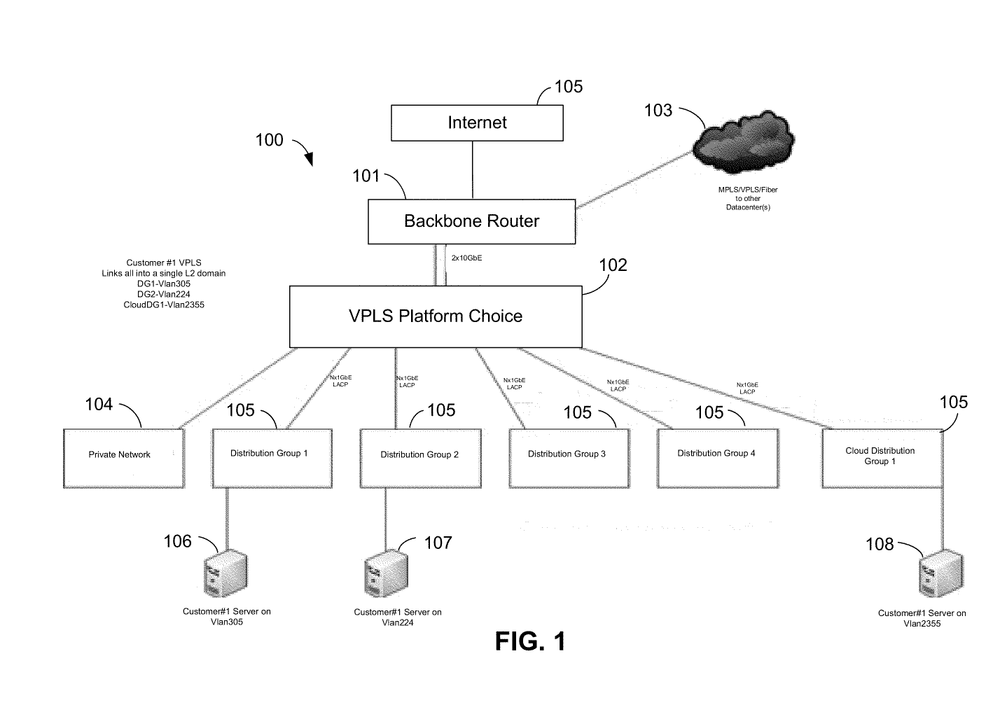

FIG. 1 illustrates a high-level overview of a hybrid network 100 suitable for automated provisioning according to embodiments of the present invention. In FIG. 1, backbone router 101 is used to connect the hybrid network of one datacenter to the internet 110 and to one or more other datacenters 103. Customer servers, either on-premises servers 106, 107, or virtual machine servers 108, are connected to the hybrid network through various distribution groups (DGs) 105. Note that for servers 106 and 107, which are connected to different distribution groups (DGs 1 and 2 respectively) no data sharing or communication would typically occur between those two servers. A typical prior art hybrid network would use a VPN to communicate between the servers on different distribution groups.

The a hybrid network 100 of FIG. 1, however, makes use of VPLS Platform 102 to allow communications between all servers no matter what distribution group they are connected to. As described in more detail herein, the use of a layer 2 technology such as Virtual Private LAN Service (“VPLS”) and/or Multiprotocol Label Switching (“MPLS”) allows for much easier provisioning of the servers on the network, while still allowing the network to function efficiently. In particular embodiments, a hybrid network according to the present invention is a true native hybrid platform and not a contrived hybrid platform making use of additional bridges and connectors. A hybrid network according to embodiments of the present invention also does not require or make use of additional firewalls, load balancers, or other layer 3 devices, which would make provisioning more complicated.

In the embodiment of FIG. 1, the servers (106, 107, 108), including any servers on private network 104, are connected to each other by way of the VPLS platform, which results in a private network between the servers where the shared data does not actually leave the datacenter. Particular embodiments of the present invention make use of layer 2 technologies such as MPLS and VPLS to “slingshot” network traffic within the datacenter itself. Surprisingly, Applicants have found that layer 2 technologies used in this fashion do not suffer significantly from their frequently mentioned disadvantages of broadcast confusion or loss of efficiency due to a high volume of repeated data packets. MPLS and VPLS originated as a way to provide WAN connectivity across great distances. By employing layer 2 technologies such as MPLS and VPLS within the data center, however, Applicants have determined that the known disadvantages of layer 2 technologies can be avoided. This allows embodiments to provide Layer 2 adjacency of devices, transparently to users, without having to set up or configure VPNs or modifying routing tables on networked devices themselves.

According to embodiments of the present invention, a customer ordering service can select a particular server or service net to add to an existing or a new hybrid network. The selection can be made using, for example, a graphical interface which allows a customer to “drag and drop” icons representing the desired network components. Once the network to be prepared and equipped has been customized according to the customer's selections, the selections can be dropped into a standard message queue, which can be used for the provisioning process. The message queue handler can then send out messages in an orchestrated fashion to actually cause the network to be provisioned or to cause services to be removed from the network.

In a particular embodiment, a router employing layer 2 switching is used as the core of the hybrid network, such as for example a Brocade MLXe series router. Such a device handles the tagging/labeling of network packets, and the subsequent slingshotting of traffic within the datacenter.

In some embodiments, three core systems will be utilized for provisioning automation:
A first system, which can be any server, should create a request for a hybrid network to be created or for a server to be added/removed from an existing hybrid network (i.e. order forms, provisioning systems, etc.).
A second system (also a server) is a Message Bus, which will handle the requests from the Request system (such as the message queue described above). The Message Bus will determine the appropriate actions to take place for provisioning a hybrid network.
A third system, the main system server, should handle all actions from the Message Bus that will allow for the hybrid network to be provisioned. This third system server will determine the appropriate name of the network, the network identifier(s), the datacenters that are involved, and the actual servers or group of servers that will be connected to the hybrid network. This will serve to interconnect all of the servers and allow communication between all servers to appear as though the servers are in the network with perceived Layer 2 adjacency, even though the servers may be separated by either a networking distribution group and sub-netting or by a datacenter.

The automated provisioning process according to particular embodiments can include of all three systems stated above communicating to and with each other. The Message Bus (in conjunction with, for example, a message queue as described above) is the orchestration layer that allows guaranteed deliver of the request/response that will allow for the hybrid network to determine the identifier and name, as well as any predetermined constraints that might be necessary, for the hybrid network. Once the hybrid network is established and configured successfully, the Message Bus will then determine by the request, from system one, the servers that will be associated with the hybrid network.

Adding services to a hybrid network from a server that creates the request (such as the first server described above) will interact with the Message Bus in the same fashion as the provisioning process. This time the network is gathered from the request and determines whether the hybrid network is still a valid network known to the third system and whether the server being added to the hybrid network already belongs to a different hybrid network. Once these two conditions are successfully verified, the Message Bus will push the notification to the third system to add the server to the existing hybrid network. A user can then automatically be connected to the hybrid network and can begin using the new service.

To remove services from a hybrid network, in some embodiments, the first system will send a request to the Message Bus to remove a server from an existing hybrid network. The Message Bus will perform necessary steps to ensure validation of both the network and the server to be removed from the hybrid network. Once validated, the Message Bus will push the notification to the third system to remove the server from the defined hybrid network.

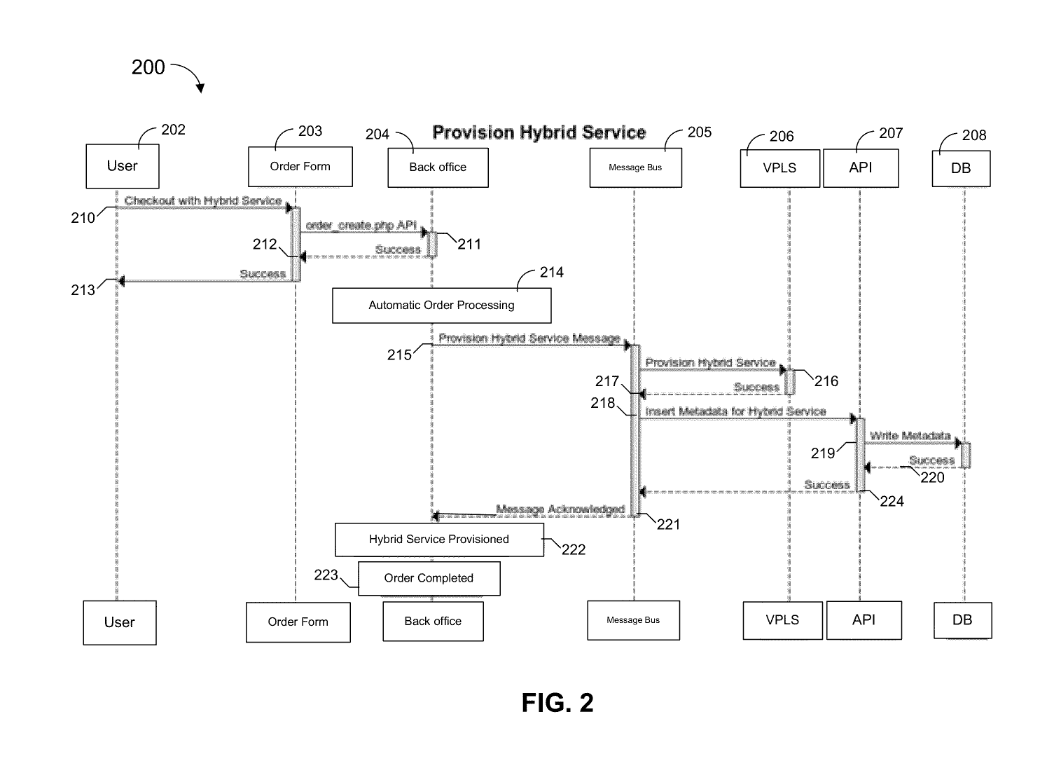

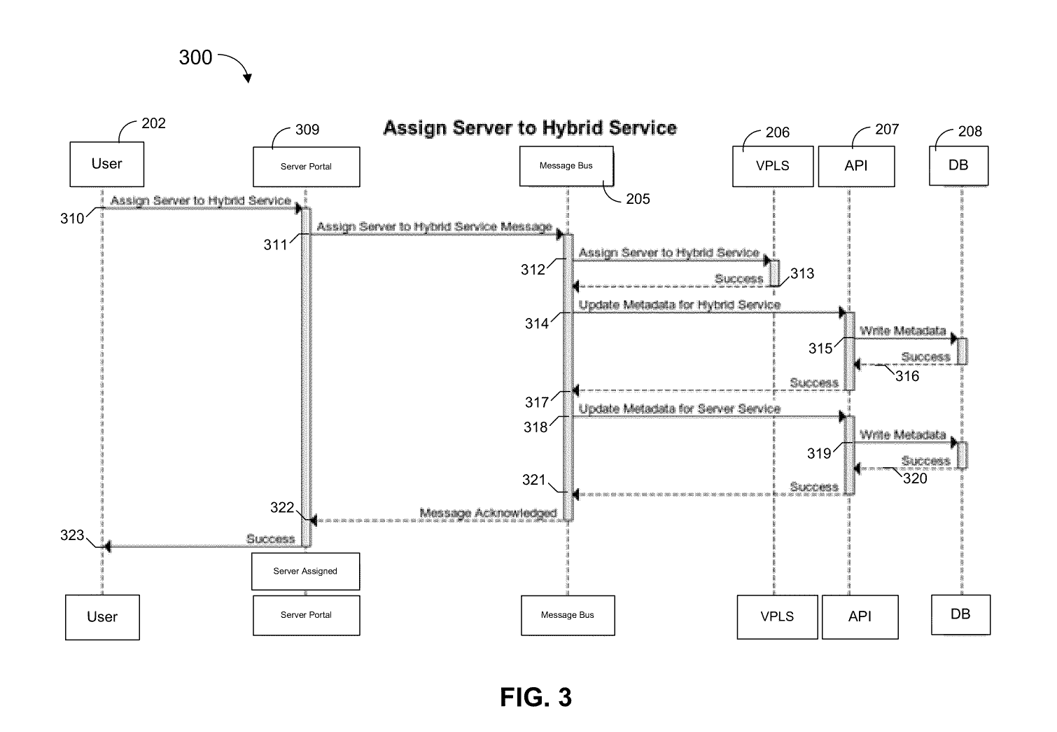

FIG. 2 shows an example of system logic that could be used to provision hybrid service on a hybrid network according to embodiments of the present invention. “Swim lane” diagrams, such as the one shown in FIG. 2, may be used to show the relationships between the various components in a computing process and to define the steps involved in such a process. FIG. 2, along with FIGS. 3-6, described below, may also represent a high-level block diagram of components of the invention implementing the steps thereof. The steps may be implemented by way of computer program code in combination with the appropriate hardware.

In the example shown in FIG. 2, a user 202 first selects a hybrid service, such as a hybrid network, along with features like connection speed or overall size of the network. Once the selection is made, the user can initiate a checkout process (210) using an order form 203 where the network is ordered and payment can be made. In particular embodiments, the ordering process can take place online using a computer connected to a webpage belonging to the cloud network service provider, or through any other suitable ordering means. Once the user has completed the checkout process, in 211 the order form and associated information can be sent to the service provider's back office support and billing system 204, which can be, for example, a computer program that collects and stores the user's checkout data. Once the data is received, the back office system 204 can issue a success message to be forwarded back to the user (212).

The back office system can then institute the automated order processing (213) and provisioning of the network. In 214, a message to begin provisioning the requested network is sent to the message bus 205, which in turn sends a provisioning message (215) to the layer 2 communication system, such as software controlling and implementing VPLS 206, issuing instructions to establish the hybrid network. In some embodiments, the network is successfully “created” (217) although no servers or services have yet been added. Metadata concerning the new hybrid network can be forwarded (218) to an Application Programming Interface (API) 207 that interacts with the service provider's back office support system, which in turn forwards metadata (219) to a database program 208 that records the information concerning the hybrid network for later retrieval by the back office support and billing systems. Success and acknowledgement messages are sent back up the line (217, 220, 224) confirming the successful provisioning of the hybrid network.

Once the network has been established, the next step could be to add servers or services to the network. FIG. 3 shows an example of system logic 300 that could be used to assign a server (or servers) to the hybrid network according to embodiments of the present invention. The user 202 elects a server to be added to the network and indicates the selection to the server portal 309, for example by using a graphical interface allowing the user to drag and drop icons representing the selected server(s) onto an icon representing the new hybrid network. Once the selection message is received, a message is sent (311) to the message bus 205, which in turn sends a message (312) to the VPLS implementation system to assign the particular server to the hybrid network. Metadata confirming the assignment is forwarded (314, 318) to the API 207 (314, 318) and database 208 (315, 319), and confirmation messages can be returned upstream (316, 320, 317, 321, 313). The process can be repeated for all desired servers or services.

Significantly, because layer 2 technologies are employed in particular embodiments, the devices to be added to the network have fixed MAC addresses that do not depend upon the physical location of the devices. As a result, the communication between the VPLS platform and the server can be easily implemented in an automated fashion, allowing the provisioning process to take place very quickly. In particular embodiments, the entire provisioning process (which is initiated after the user places a network order and makes server and/or service selections) is completed without human intervention in not more than 10 minutes, no more than 5 minutes, no more than two minutes, no more than 1 minute, or in less than 1 minute.

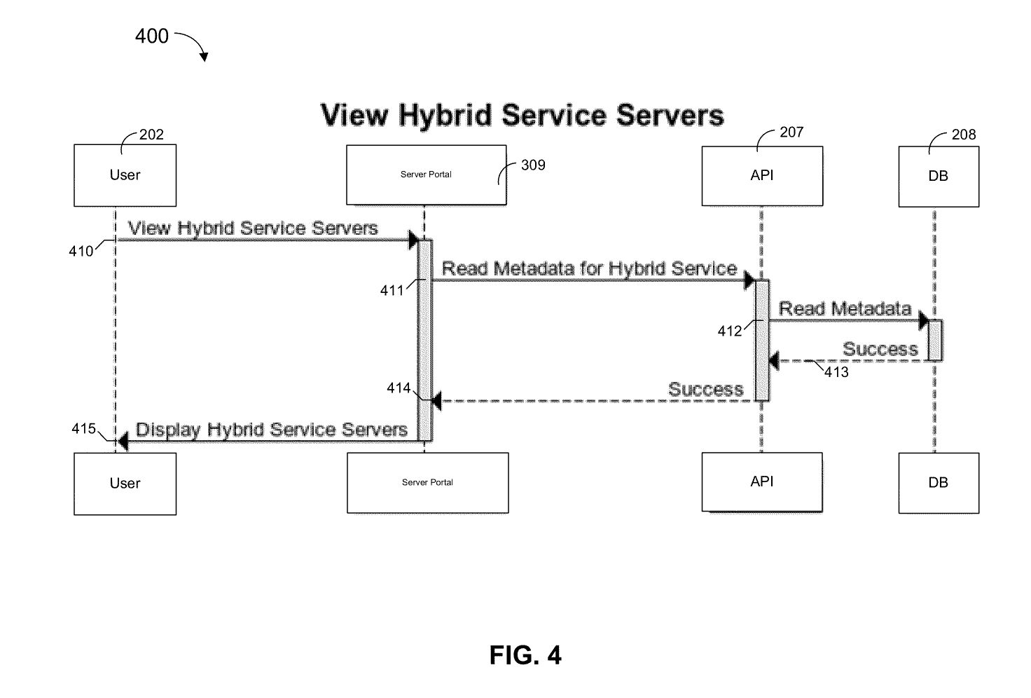

FIG. 4 shows an example of system logic 400 that could be used to view the hybrid service servers according to embodiments of the present invention, which could be used, for example, to allow a user to confirm the network and server provisioning. A command to view the hybrid servers (410) can be sent by the user 202 to the server portal 309 using, for example, a computer and interface (not shown). The server portal system can retrieve metadata (411, 412) concerning servers in the hybrid network from the database 208 and API 207, which can then be displayed (415) to the user, for example, on a computer screen. Success and acknowledgement messages are sent back up the line (413, 414).

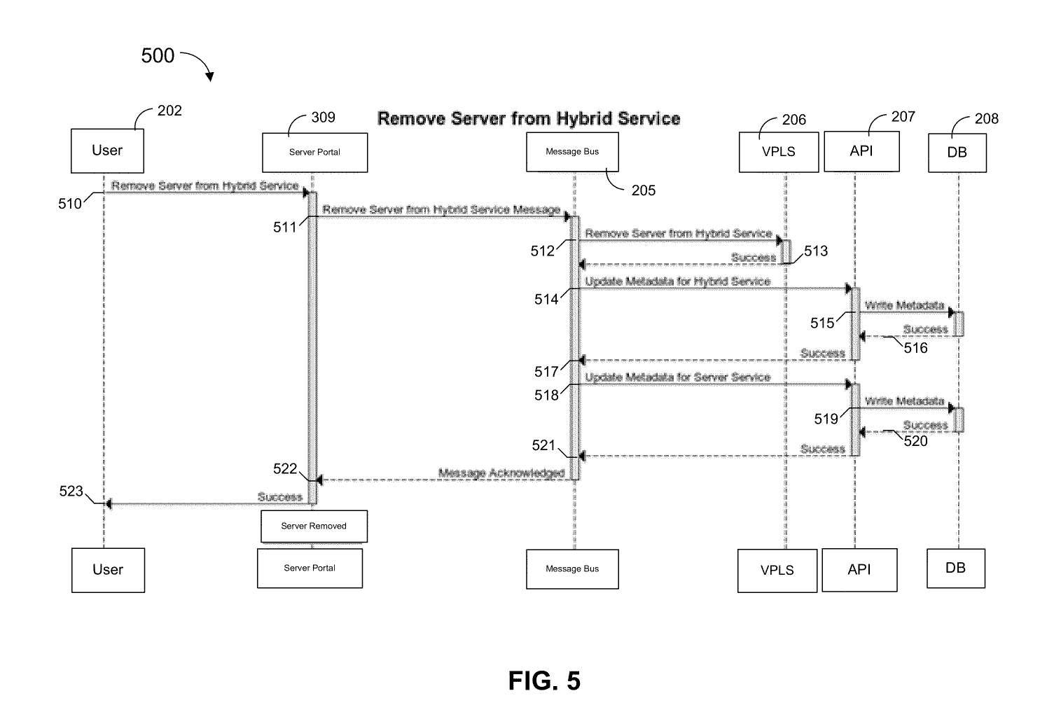

FIG. 5 shows an example of system logic 500 that could be used to automatically remove a server (or servers) from the hybrid network according to embodiments of the present invention. The system logic in FIG. 5 is essentially the reverse of the server addition process shown in FIG. 3. A command to remove a particular server from the hybrid network is issued by the user to the server portal system (510), which in turn forwards that instruction to the messaging system (511). The messaging system sends a message directing the server removal to the VPLS implementation system (512), which reports the successful removal back to the messaging system (513). Instructions to update the network information in the API 207 (514, 518) and database 208 (515, 519) are then forwarded, followed by reports indicating the successful removal that are sent back upstream (516, 520, 517, 521, 513, 522, 523).

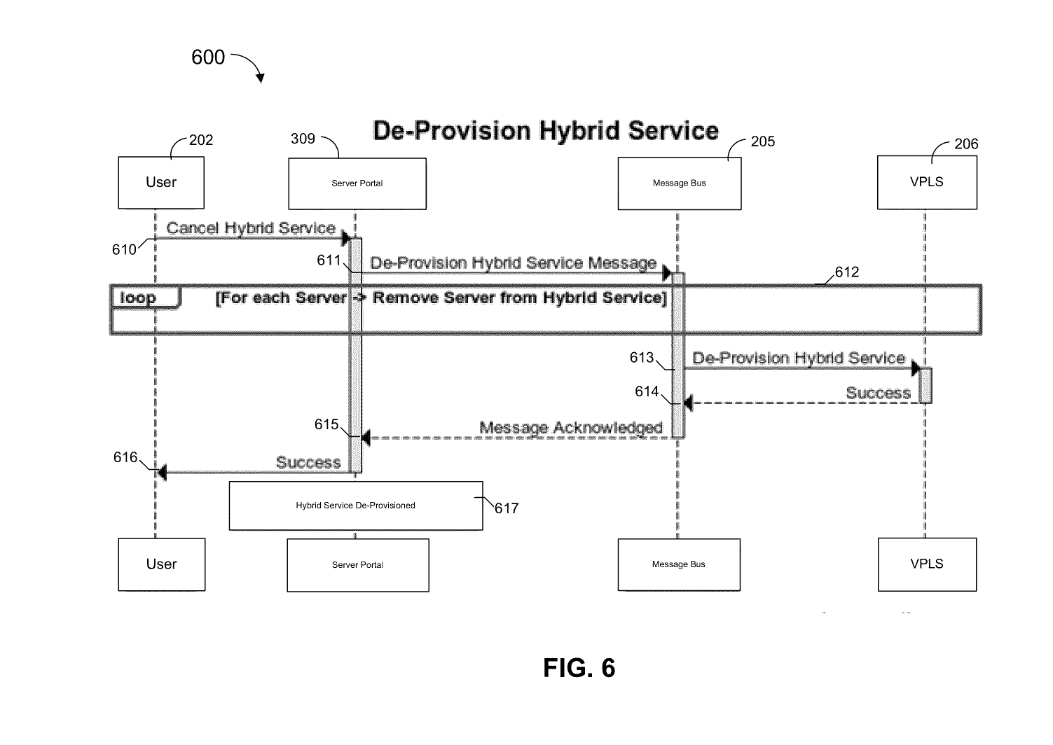

FIG. 6 shows an example of system logic 600 that could be used to automatically de-provision an entire hybrid network according to embodiments of the present invention. A user 202 first sends a message (610) to the server portal system 309 to cancel the hybrid network service, which causes a de-provision instruction (611) to be forwarded to the messaging bus 205 for each server or service in the network in a message loop 612 that repeats for each server. The messaging bus sends the de-provision information (613) for each server or service to the VPLS implementation system. Once the VPLS implementation system has caused the servers and/or systems to be de-provisioned, confirmation messages are returned upstream to the user (614, 615, 616) confirming that the entire hybrid network has been de-provisioned (617).

Significantly, these embodiments described above can all proceed automatically once a user initiates the particular process. As used herein, the term automatically will include a manual initiation of the process by a user, including an initiation requiring the user to make one or more selections of the servers and/or services to be included/removed before the provisioning/de-provisioning process will proceed. The use of layer 2 technologies allows the automation to be easily accomplished. And Applicants have confirmed that surprisingly the use of layer 2 technologies does not cause a significant decrease in efficiency or a significant increase in broadcast traffic congestion. Accordingly, embodiments of the present invention are still scalable to produce networks of almost any size.

A system, method, or computer program product according to embodiments of the present invention has many novel aspects. Because the invention can be embodied in different systems, methods, or computer program products for different purposes, not every aspect need be present in every embodiment. Moreover, many of the aspects of the described embodiments may be separately patentable. The figures described herein are generally schematic and do not necessarily portray the embodiments of the invention in proper proportion or scale unless otherwise stated.

The invention described herein has broad applicability and can provide many benefits as discussed and shown in the examples herein. The embodiments will vary greatly depending upon the specific application, and not every embodiment will provide all of the benefits and meet all of the objectives that are achievable by the invention. Note that not all of the activities described above in the general description or the examples are required, that a portion of a specific activity may not be required, and that one or more further activities may be performed in addition to those described. Still further, the order in which activities are listed are not necessarily the order in which they are performed.

As will be appreciated by one skilled in the art, aspects of the present invention may include a system, method, or computer program product embodied entirely in hardware or in a combination of software and hardware. The program environment in which one embodiment of the invention may be executed illustratively incorporates one or more general-purpose computers or special-purpose devices such hand-held computers. Details of such devices (e.g., processor, memory, data storage, input and output devices) are well known and are omitted for the sake of clarity.

Furthermore, aspects of the present invention may take the form of a computer program product embodied in at least one physical (e.g., non-transitory) computer-readable medium having computer-readable program code embodied thereon. The computer-readable medium may be a computer-readable signal medium, including but not limited to an electronic, magnetic, optical, electromagnetic, infrared, or semiconductor system, apparatus, or device, or any suitable combination thereof, or a computer-readable storage medium, including but not limited to an electronic, magnetic, optical, electromagnetic, infrared, or semiconductor system, apparatus, or device, or any suitable combination thereof. More specific non-limiting examples of the computer-readable storage medium would include the following: an electrical connection having at least one wire, portable computer diskette, hard disk, random access memory (RAM), read-only memory (ROM), erasable programmable read-only memory (EPROM or Flash memory), optical fiber, portable compact disc read-only memory (CD-ROM), optical storage device, magnetic storage device, or any suitable combination thereof. As used herein, a computer-readable storage medium may be any tangible medium that can contain, or store a program for use by or in connection with an instruction execution system, apparatus, or device.

Computer program code for carrying out operations for aspects of the present invention may be written in any combination of at least one programming language. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

It should also be understood that the techniques of the present invention might be implemented using a variety of technologies. Computer-program instructions may be provided to a processor of a general purpose computer, special purpose computer, or other programmable data processing apparatus to produce a special purpose machine for implementing the functions/acts specified in the flowchart and/or block diagram blocks. The computer-program instructions may also be loaded onto a computer, other programmable data processing apparatus, or other device to cause a series of operational steps to be performed to produce a computer-implemented process such that the instructions which execute on the computer or other programmable apparatus provide processes for implementing embodiments of the invention.

The flowchart and block diagrams in the figures herein illustrate the architecture, functionality, and operation of possible implementations of systems, methods, and/or computer program products according to various embodiments of the present invention. As such, each block in the flowchart or block diagrams may represent a module, segment, or portion of code comprising at least one executable instruction for implementing the specified logical function(s). It should also be noted that, in some alternative embodiments, the order in which the blocks are listed are not necessarily the order in which the functions or activities noted in the block are performed. For example, two blocks shown in succession may be executed substantially concurrently, or the blocks may sometimes be executed in the reverse order, depending upon the functionality involved. It will also be noted that each block and/or combinations of blocks in the diagrams and/or flowcharts can be implemented by special purpose hardware-based systems that perform the specified functions or acts, by or combinations of special purpose hardware and computer program instructions.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments described herein were chosen and described in order to best explain the principles of the invention and the practical application, and to enable others of ordinary skill in the art to understand the invention for various embodiments with various modifications as are suited to the particular use contemplated.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention. After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range. Whenever the terms “automatic,” “automated,” or similar terms are used herein, those terms will be understood to include manual initiation of the automatic or automated process or step.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present). Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

Although the present invention and its advantages have been described in detail, it should be understood that various changes, substitutions and alterations can be made to the embodiments described herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of provisioning a hybrid network, the method comprising:
providing a hybrid network where at least a plurality of servers and/or systems in the network are connected to each other by using a layer 2 switching device;
receiving an order from a user requesting the creation of a hybrid network and the addition of at least two servers and/or systems to the network; and
automatically provisioning the requested hybrid network without manual intervention.

2. The method of claim 1 in which automatically provisioning the requested hybrid network without manual intervention comprises automatically configuring communication between at least a plurality of servers and/or systems in the network by using the MAC addresses of the servers and/or systems in the network or by using the MAC addresses of communications devices connected to the plurality of servers and/or systems.

3. The method of claim 1 in which the layer 2 switching device comprises a VPLS or MPLS device.

4. The method of claim 1 in which the layer 2 switching device is used to connect servers and/or systems within the same data center.

5. The method of claim 1 in which the layer 2 switching device is used to connect servers and/or systems on different network distribution groups but that are physically located within the same data center.

6. The method of claim 1 in which the hybrid network does not make use of any layer 3 devices to connect servers and/or systems on the hybrid network.

7. The method of claim 1 in which automatically provisioning the requested hybrid network comprises provisioning the requested hybrid network without setting up or configuring VPNs or modifying routing tables on the networked servers and/or systems.

8. The method of claim 1 in which automatically provisioning the requested hybrid network comprises automatically provisioning the requested hybrid network in a process manually initiated by a user.

9. The method of claim 1 in which the plurality of servers and/or systems in the network are connected to each other by using a layer 2 switching device used to form a private network between the servers and/or systems such that data shared between the servers and/or systems does not leave the datacenter where the servers and/or systems are located.

10. The method of claim 1 in which the hybrid network comprises a plurality of dedicated private servers and/or systems and at least one shared cloud server.

11. A computer-implemented method of creating a hybrid cloud network in response to an order received from a user, the method comprising:
creating a hybrid network for connecting a plurality of servers using OSI layer 2;
assigning a plurality of servers to the hybrid network; and
automatically configuring the connections between the plurality of servers.

12. The computer-implemented method of claim 11 in which automatically configuring the connections between the plurality of servers comprises automatically configuring the connections between the plurality of servers without human intervention in not more than 10 minutes, no more than 5 minutes, no more than two minutes, no more than 1 minute, or in less than 1 minute.

13. The computer-implemented method of claim 11 in which automatically configuring the connections between the plurality of servers comprises automatically configuring communication between at least a plurality of servers and/or systems in the network by using the MAC addresses of the servers and/or systems in the network or by using the MAC addresses of communications devices connected to the plurality of servers and/or systems.

14. The method of claim 11 in which creating a hybrid network for connecting a plurality of servers using OSI layer 2 comprises creating a hybrid network for connecting a plurality of servers using a VPLS and/or MPLS device.

15. The method of claim 11 in which the connected servers are located within the same data center.

16. The method of claim 14 in which the VPLS and/or MPLS device is used to connect servers on different network distribution groups but that are located within the same data center.

17. The method of claim 11 in which the hybrid cloud network does not make use of any layer 3 devices to connect servers on the hybrid network.

18. The method of claim 11 in which automatically configuring the connections between the plurality of servers comprises automatically configuring the connections between the plurality of servers without setting up or configuring VPNs or modifying routing tables on the networked servers.

19. The method of claim 11 in which automatically configuring the connections between the plurality of servers comprises automatically configuring the connections in a process manually initiated by a user.
